(19) United States
(12) Patent Application Publication
(10) Pub. No.: US 2025/0347793 A1
(43) Pub. Date: Nov. 13, 2025

(54) SYSTEM AND METHOD FOR EVENT DETECTION AND TRACKING USING OPTICAL AND ACOUSTIC SIGNALS

(71) Applicant: ELTA SYSTEMS LTD., Ashdod (IL)

(72) Inventors: Sasson NISSIM, Rishon Lezion (IL); Jacob ROVINSKY, Modiin (IL); Noam FRENKEL, Karmey Yosef (IL); Erez SHARON, Karmei Yosef (IL)

(21) Appl. No.: 19/138,385

(22) PCT Filed: Dec. 11, 2023
(86) PCT No.: PCT/IL2023/051258

§ 371 Date: Jun. 12, 2025

(30) Foreign Application Priority Data
Dec. 12, 2022 (IL) 299059

(51) Int. Cl. G01S 11/16; F41G 3/14; G06T 7/20; G06T 7/70; H04R 1/40; H04R 3/00

(52) U.S. Cl. CPC G01S 11/16; F41G 3/147; G06T 7/20; G06T 7/70; H04R 1/406; H04R 3/005

(57) ABSTRACT

A method and respective system are described, suitable for detecting location and/or path of event. The method comprises obtaining input data comprising optical input data from at least one optical sensor arrangement and acoustic input data from an acoustic sensor arrangement. Processing the input data to detect a first signal indicative of selected events in at least one of the optical input data and acoustic input data, and in response to detecting an event registering a time of collection of the first signal and determining an estimated location of the event. Processing input data of other one of the optical and acoustic input data to determine input signal indicative of a second signal associated with the event. Determining time of collection of the second signal and determining a time difference between time of collection of the event. Utilizing the time difference to determine event location.

### TECHNOLOGICAL FIELD

The present disclosure relates to systems and methods for detection and tracking projectile and other moving objects using combined acoustic and optical input data. The technique of the present disclosure specifically relates to detection and monitoring of events associated with moving objects for detection of launch path and impact of such objects.

### BACKGROUND

Detecting and monitoring moving objects or events generally includes identifying relative location between a selected point and the object. Various techniques are known for determining object location including triangulation, time of flight measurements etc.

Detection of object's distance using time difference between collected signals that travel in different speeds provides a robust and simple technique for identifying object's location. For example:

US20180259613 describes an object detection device includes a microphone array that includes a plurality of non-directional microphones, and a processor that processes first sound data obtained by collecting sounds by the microphone array. The processor generates a plurality of items of second sound data having directivity in an arbitrary direction by sequentially changing a directivity direction based on the first sound data, and analyzes a sound pressure level and a frequency component of the second sound data, and determines that an object exists in a first direction in a case where a sound pressure level of a specific frequency, which is included in the frequency component of the second sound data having directivity in the first direction of the arbitrary direction, is equal to or larger than a first prescribed value.

WO2016087661 describes a method of estimating the trajectory of a mobile source (S_{M}) in a plane in space by passive pathway, the mobile source (S_{M}) generating at least one first signal (S₁) and one second signal (S₂) propagating respectively at two different speeds, comprises: an acquisition of the signals (S₁, S₂) by at least one antenna (ANT₁, ANT₂); an estimation of angles (DET₁) of at least four angles of arrival (θ₁, θ₂, θ₃, θ₄) of which at least one angle (θ₁) corresponds to a measurement of the angle of arrival of the first signal (S₁), and of which at least one angle (θ₂) corresponds to a measurement of the angle of arrival of the second signal (S₂) by at least one antenna (ANT₁, ANT₂); an estimation of a position and of a speed vector (V_{SM}) of the mobile source (SM) at a given instant (tᵢ).

WO2012107070 relates to a method for passively ascertaining the position of an object, having the method steps of ascertaining bearing data, wherein the bearing data includes the direction of the object and the point in time of the bearing, and two different types of bearing data are ascertained, namely acoustic bearing data and visual bearing data; storing the bearing data; identifying bearing data of different types as belonging to the same bearing; calculating the distance of the object from the time difference of the points in time of the bearings that are identified as belonging to the same bearing; and calculating the position of the object from the direction and the distance of the object.

### General Description

The present disclosure provides a system and corresponding method, utilizing collection of optical and acoustic signals for detection of events and/or moving objects. The present technique may be used for identifying instantaneous object location as well as monitoring path of movement of a detected object and/or expected destination or impact location. The present disclosure may generally be used for identifying various object types and respective events and may relate specifically to detection of projectile or rockets launches, as well as determining path and estimated impact position of the projectiles and/or rockets.

To this end, the present disclosure provides a system comprising at least one optical sensor arrangement configured to collect image data pieces indicative of image of surroundings of the system. The optical sensor arrangement may include one or more sensors configured for detecting electromagnetic radiation in selected wavelength range. Such optical sensor arrangement may operate as an imager/camera operating in visible and/or IR wavelength range or configured as an arrangement of one or more sensors enabling sensing of variation in illumination intensity, e.g., arrangement of one or more photodiodes. In some preferred embodiments, the optical sensor arrangement may provide output data indicative of mapping of radiation intensity in one or more wavelength range as a function of angles with respect to a selected main axis (e.g., image data). Additionally, the system comprises an acoustic sensor arrangement, generally comprising an array of two or more microphones configured for collecting acoustic signals. The optical sensor arrangement and acoustic sensor arrangement are configured and operable for collecting respective optical and acoustic signals and transmit corresponding data to a control unit for analyzing and processing. Generally, the optical sensor arrangement and the acoustic sensor arrangement are configured to operate with respective selected sampling rates to provide time dependent data indicative of collected optical and acoustic signals.

The technique of the present disclosure utilizes input data comprising optical and acoustic input data, for determining location and/or path of events utilizing time correlation between collected signals and time difference between collection of optical signals and associated acoustic signal of common or correlated events. In some typical examples, the present technique may utilize pre-stored data indicative of typical path of one or more projectiles, and one or more characteristic signals thereof to determine correspondence between a first event detected by optical or acoustic input data, and a second event detected by other one of the optical or acoustic input data. Further, in some embodiments, the present technique may utilize such pre-stored data for determining path of one or more projectiles based on the detected first and second events and may thus determine estimated impact location.

As indicated above, the present technique may operate by a control unit associated with one or more optical sensor arrangement and acoustic sensor arrangement. The control unit generally comprises at least one processor and memory unit and is configured and operable to receive optical input data from the at least one optical sensor arrangement, and acoustic input data from the acoustic sensor arrangement, and to process the data to determine at least location data on one or more events or objects detected in the input data. Additionally, the control unit may operate the at least one optical sensor arrangement and the acoustic sensor arrangement for collecting input signals at a selected sampling rate, being fixed or dynamic sampling rate during operation. The control unit may generally be configured to process the collected signals to identify signal portions that may be indicative of events such as launch of a flying object, propagation of flying objects and/or impact of such flying objects. For example, such objects may be projectiles and/or rockets, or any other moving/flying objects. In this connection, the control unit may operate the at least one processor is accordance with pre-stored computer readable instructions, typically stored in the memory unit. The control unit may comprise various operational or functional hardware and/or software modules for performing selected tasks as described herein below.

The system of the present disclosure, may be installed or mounted on a mobile platform such as moving vehicle etc. Accordingly, the system may further comprise, or be associated with a location sensor providing data on location or changes in location of the vehicle. The present disclosure provides detection of event location using optical and acoustic signals while moving, i.e., the system location at time of collection of a first optical signal may be different than the system location when collecting a second acoustic signal. To this end, the control unit may be operable to received location data from the location sensor, utilize the location data to determine an estimated location of the event based on first collected signal, and determine location variation upon collecting a second signal associated with the event. The control unit may utilize azimuth data of the collected signals to determine correspondence between first and second collected signals, and use the azimuth data, time difference in signal collection and location variation data of the system to determine distance to the event.

To this end, the present disclosure utilizes processing collected signals to detect signal associated with one or more types of events or objects to be detected. Such events or objects may generally include projectiles or rockets related signals including e.g., any one of: launch flash, launch blast, detonation flash, detonation blast, detonation impact, flight flare, flight sound, projectile's movement etc.

As indicated above, in response to detecting a respective signal, in either one of the optical input data and acoustic input data, the technique of the present disclosure may operate to further process the collected signals and utilize time difference between signal data collected using optical sensor arrangement and acoustic sensor for determining distance to the object or event.

To this end, the present technique utilizes processing further collected signals, to detect one or more signal portions indicative of further events or objects and determining correlations between additional detected data and events or objects detected. The technique utilizes time difference in detection of a common event or object using optical and acoustic sensors to determine distance of the event or object, and to further monitor its trajectory.

Generally, the system and method of the present disclosure are configured to be implemented when mounted/installed of a mobile ground or aerial vehicle. The system may also comprise or be associated with at least one location sensor configured to provide output data on at least one of location of the vehicle or change in location of the vehicle. For example, the location sensor may comprise a global positioning system or any other satellite-based location system. In some other examples, the location sensor may comprise one or more accelerometers, gyroscopic location sensor or any other Inertial measurement unit (IMU).

According to some embodiments of the present disclosure, the present technique utilizes location data obtained from the location sensor, to determine system movement within time period between collection of a first signal indicating an event to be detected, and collection of a second signal indicating the event. The present technique may thus utilize data on variation in location thereof, in combination with time difference in collection of optical and acoustic signals, and data on relative azimuth from which the optical and acoustic signals are collected, to determine event location.

The collected optical input signals can generally be represented by one or more images typically forming an image stream, each image is indicative of a scene at a respective time of acquisition and is collected with a selected heading of the camera. Accordingly, an event or object may be detected in image data based on changes between images with time. Additionally, relative angular location of the detected event/object can be directly determined from the acquired image.

Further, the acoustic sensor arrangement generally comprises two or more acoustic sensors arranged in an array. To determine angular location based on acoustic signal, the control unit utilizes determining phase relations between acoustic signals collected by the two or more acoustic sensors may be used.

Accordingly, in response to input signal indicative of a launch, or rocket propagation, collected by the at least one camera unit, the processing unit operates the array of microphones for collecting acoustic signal from general direction associated with optically detected location and for processing the collected acoustic data to determine acoustic signal indicative of launch, or rocket propagation, having correspondence with the optical input signal.

The processing unit may further operate for determining correlations between optical and acoustic data on launch and rocket propagation, to determine distance of the rocket from the system, launch location, and expected impact location. The processing may also utilize pre-stored data on one or more rocket types/models and respective optical and acoustic signatures for determining rocket type/model. Using data on rocket type, the system enables improved processing of rocket heading and trajectory based on appearance of the rocket in the collected optical/image data. More specifically, image data provides indication on orientation of the rocket (being observed as a circle, elongated shape etc.).

According to a broad aspect, the present disclosure provides a method for detecting location and/or path of event comprising:
(a) obtaining input data comprising optical input data from at least one optical sensor arrangement (camera) and acoustic input data from an acoustic sensor arrangement comprising two or more acoustic sensors;
(b) processing said input data, said processing comprising detecting a first signal indicative of one or more selected events in at least one of the optical input data and acoustic input data;
(c) in response to detecting an event in said at least one of the optical input data and acoustic input data, registering a time of collection of said first signal and determining an estimated location of said event,
(d) processing input data of other one of said optical input data and acoustic input data for determining input signal indicative of a second signal associated with said event,
(e) determining time of collected data indicative of said second signal detected in said at least one of the optical input data and acoustic input data and determining a time difference between time of collected data indicative of said event; and
(f) utilizing said time difference and determining location of said event.

According to some embodiments, the method may further comprise obtaining location data from one or more locations sensors, determining change in location during time between time of collected data indicative of said event in said optical input data and said acoustic input data, and determining location of said event in accordance with said time difference and said change in location.

According to some embodiments, the method may further comprise obtaining location data from one or more orientation sensors, determining change in orientation during time between time of collected data indicative of said event in said optical input data and said acoustic input data, and determining location of said event in accordance with said time difference and said change in orientation.

According to some embodiments, the method may comprise determining change in location and orientation and using data on said change in location and orientation for determining location of said event.

According to some embodiments, the at least one first signal is indicative of one or more of the following: launch flash, launch blast, detonation flash, detonation blast, detonation impact, flight flare, flight sound, projectile's movement.

According to some embodiments, the second signal and the at least one first signal are indicative of a common event.

According to some embodiments, the second signal is indicative of a continuation event associated with event detected in said first signal.

According to some embodiments, the at least one first signal may be associated with launch of a projectile and the second signal being indicative of flight of said projectile.

According to some embodiments, the method may further comprise processing of the input data for classifying said at least first signal and obtaining pre-stored data indicative of one or more items associated with said at least one first signal and determining data on object type of said at least one first signal.

According to some embodiments, the method may further comprise using one or more pre-stored parameters of an item associated with said at least one first signal for determining at least one of anticipated path and anticipated impact position of said item. According to some embodiments, the method may further comprise determining location of one or more events in accordance with time difference of data indicative of said one or more events in said optical input data and acoustic input data at a selected processing rate, thereby determining path of movement of said one or more events.

According to some embodiments, the second signal may be a continuous signal, the method comprises determining data on angular velocity of source of said second signal and determining correspondence between said second signal and said first signal in accordance with event characteristics and said angular velocity.

According to some embodiments, the method may further comprise determining Doppler shift variation of said second continuous signal and determining closing velocity of said event.

According to some embodiments, the method may further comprise determining Doppler shift variation and determining whether said event relates to projectile propagating generally toward or away from said at least one acoustic sensor arrangement.

According to some embodiments, the method may further comprise processing data of said first signal for determining one or more event characteristics and determining correlation between said second signal and said first signal in accordance with at least one of typical projectile velocity and path curve variation.

According to some embodiments, the method may further comprise processing data on said path of movement of said one or more events and using at least one of physical pre-stored model and path history of said one or more events and determining expected future path of said one or more events.

According to some embodiments, the method may further comprise determining expected impact point based on determined path of a projectile associated with said event.

According to some embodiments, said detecting input signal indicative of at least one first signal in at least one of the optical input data and acoustic input data may comprise processing said input data using machine learning classification for detecting said at least one first signal.

According to some embodiments, said determining an estimated location of said at least one first signal may comprise processing optical input data and determining at least angular location of said at least one first signals in said optical input data.

According to some embodiments, said determining an estimated location of said at least one first signal may comprise processing acoustic input data collected by said two or more acoustic sensors and determining relative angular position of source of acoustic signal indicative of said at least one first signals using phase relations of acoustic signals collected by said two or more acoustic sensors.

According to some embodiments, said determining input signal indicative of a second signal associated with said at least one first signal may comprise determining correlation between estimated location of said at least one first signal and estimate location of said second signal and determining that said second signal is associated with said at least one first signal in response to correlation exceeding an event correlation threshold.

According to one other broad aspect, the present disclosure provides a system comprising at least one optical sensor arrangement, an acoustic sensor arrangement comprising two or more acoustic sensors, and a control unit adapted for receiving optical input data from said at least one camera unit and acoustic input data from said acoustic sensor arrangement;

the control unit comprises at least one processor and memory unit and is configured for:
(a) obtaining input data comprising optical input data from at least one optical sensor arrangement (camera) and acoustic input data from an acoustic sensor arrangement comprising two or more acoustic sensors;
(b) processing said input data, said processing comprising detecting input signal indicative of at least one first signal in at least one of the optical input data and acoustic input data;
(c) in response to detecting an event in said at least one of the optical input data and acoustic input data, registering a time of collection of said event and determining an estimated location of said at least one first signal,
(d) processing input data of other one of said optical input data and acoustic input data to determine input signal indicative of a second signal associated with said at least one first signal,
(e) determining time of collected data indicative of said second signal detected in said at least one of the optical input data and acoustic input data and determining a time difference between time of collected data indicative of said at least one first signal and said second signal; and
(f) utilizing said time difference and determining location of said at least one first signal; and generating output data indicative of at least location of said at least one first signal.

According to some embodiments, the system may further comprise one or more location sensors configured to provide location data of the system, and wherein said control unit is adapted to receive said location data and to determine change in location during time between time of collected data indicative of said event in said optical input data and said acoustic input data, and determining location of said event in accordance with said time difference and said change in location.

According to some embodiments, the system may further comprise one or more orientation sensors, and wherein said control unit is adapted to receive location data from one or more orientation sensors, determine change in orientation during time between time of collected data indicative of said event in said optical input data and said acoustic input data, and determine location of said event in accordance with said time difference and said change in orientation.

According to some embodiments, the control unit may be adapted to determine change in system location and orientation, and to utilize data on said change in location and orientation for determining location of said event.

According to some embodiments, the at least one first signal is indicative of one or more of the following: launch flash, launch blast, detonation flash, detonation blast, detonation impact, flight flare, flight sound, projectile's movement.

According to some embodiments, the second signal and said at least one first signal may be indicative of a common event.

According to some embodiments, the second signal is indicative of a continuation event associated with event detected in said first signal.

According to some embodiments, the at least one first signal may be associated with launch of a projectile and said second signal being indicative of flight of said projectile.

According to some embodiments, the control unit is further adapted for processing said input data for classifying said at least first signal and for obtaining pre-stored data indicative of one or more items associated with said at least one first signal and determining data on object type of said at least one first signal.

According to some embodiments, the control unit comprises pre-stored data comprising one or more parameters indicative of selected events to be detected, and wherein said control unit is adapted for utilizing said pre-stored data for classification of detected events and determining path of moving projectiles associated with one or more selected events.

According to some embodiments, the control unit is adapted to utilize time difference between collection of said first signal and collection of said second signal being indicative of said one or more events and being collected in said optical input data and acoustic input data at a selected processing rate, thereby determining path of movement of one or more projectiles associated with said one or more events.

According to some embodiments, the control unit is adapted for detecting one or more continuous signal in at least one of said optical and acoustic input data, and to utilize sampling rate of said optical and acoustic sensor arrangement to determine angular velocity of source of said continuous signal.

According to some embodiments, the control unit is adapted to utilize data on angular velocity of source of said continuous signal to determine correspondence between a respective second continuous signal and said first signal in accordance with event characteristics and said angular velocity.

According to some embodiments, the control unit is adapted for determining doppler shift variation of said continuous signal and determining closing velocity of said event.

According to some embodiments, the control unit is adapted for determining doppler shift variation of said continuous signal and determine accordingly whether said signal is indicative of a projectile propagating generally toward or away from said at least one acoustic sensor arrangement.

According to some embodiments, the control unit is further adapted for processing data of said first signal and determining one or more event characteristics, and for determining correlation between said second signal and said first signal in accordance with at least one of typical projectile velocity and path curve variation.

According to some embodiments, the memory unit comprises pre-stored data on physical model of projectile paths, said control unit is adapted to utilize said pre-store physical model in accordance with data on said one or more events to determine expected path of said one or more events.

According to some embodiments, the expected path comprises data on at least one of impact location and launch location

According to some embodiments, the control unit comprises a pre-trained machine learning module adapted for classifying one or more events in accordance with input signal indicative of at least one first signal in at least one of the optical input data and acoustic input data.

According to yet another broad aspect, the present disclosure provides program storage device readable by machine, tangibly embodying a program of instructions executable by the machine to perform a method for detecting location and/or path of event comprising:
(a) obtaining input data comprising optical input data from at least one optical sensor arrangement (camera) and acoustic input data from an acoustic sensor arrangement comprising two or more acoustic sensors;
(b) processing said input data, said processing comprising detecting input signal indicative of at least one first signal in at least one of the optical input data and acoustic input data;
(c) in response to detecting an event in said at least one of the optical input data and acoustic input data, registering a time of collection of said event and determining an estimated location of said at least one first signal,
(d) processing input data of other one of said optical input data and acoustic input data for determining input signal indicative of a second signal associated with said at least one first signal,
(e) determining time of collected data indicative of said second signal detected in said at least one of the optical input data and acoustic input data and determining a time difference between time of collected data indicative of said event; and
(f) utilizing said time difference and determining location of said at least one first signal; and
(g) generating output data indicating of at least said location of said at least one first signal.

Generally, the program storage device may store instructions indicative of various method operations as described herein.

According to a further broad aspect, the present disclosure provides a computer program product comprising a computer useable medium having computer readable program code embodied therein for detecting location and/or path of event the computer program product comprising:
computer readable program code for causing the computer to obtain input data comprising optical input data from at least one optical sensor arrangement (camera) and acoustic input data from an acoustic sensor arrangement comprising two or more acoustic sensors;
computer readable program code for causing the computer to process said input data, said processing comprising detecting input signal indicative of at least one first signal in at least one of the optical input data and acoustic input data;
computer readable program code for causing the computer to in response to detecting an event in said at least one of the optical input data and acoustic input data, registering a time of collection of said event and determining an estimated location of said at least one first signal,
computer readable program code for causing the computer to process input data of other one of said optical input data and acoustic input data for determining input signal indicative of a second signal associated with said at least one first signal,
computer readable program code for causing the computer to determine time of collected data indicative of said second signal detected in said at least one of the optical input data and acoustic input data and determining a time difference between time of collected data indicative of said event; and
computer readable program code for causing the computer to utilize said time difference and determining location of said event, and for generating output data indicating of at least said location of said at least one first signal.

According to some embodiments, the computer program product may comprise computer readable program code for causing the computer to operate in accordance with any one of method operations as described herein.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 schematically illustrated a system for detecting object/event location according to some embodiments of the present disclosure;

FIG. 2 exemplifies a processor and memory circuitry (PMC) capable of operating the method according to some embodiments of the present disclosure;

FIG. 3 exemplifies a method for determining object/event location according to some embodiments of the present disclosure;

FIG. 4 illustrates time difference between collection of optical signal and collection of acoustic signal, indicative of event distance;

FIG. 5 exemplifies detection of event/object location using mobile system according to some embodiments of the present disclosure; and

FIG. 6 exemplifies detection of a projectile path according to some embodiments of the present disclosure.

### DETAILED DESCRIPTION OF EMBODIMENTS

As indicated above, the present disclosure provides a system and corresponding method configured for using input data of at least two different signal types, having respective first and second propagation speeds, for determining location of a target. The present technique may further utilize data on target location for determining estimated path of the target and optionally also for detecting estimated impact location.

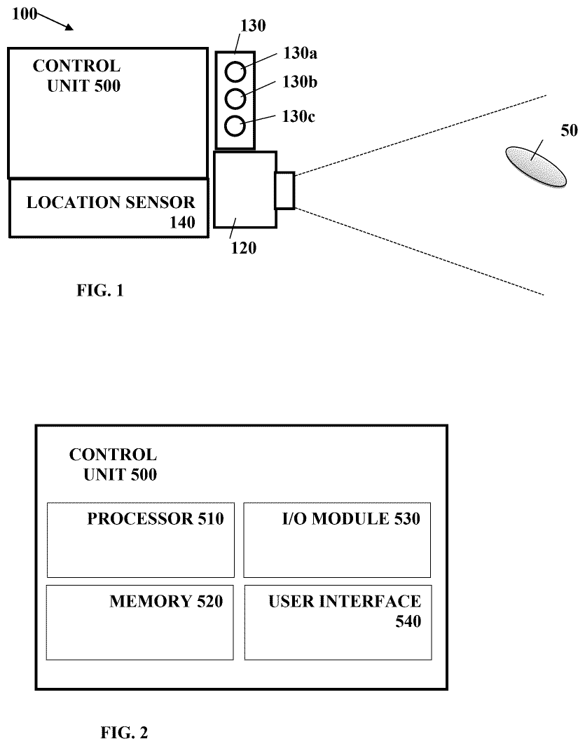

In this connection, FIG. 1 schematically illustrates a system according to some embodiments of the present disclosure. The system 100 includes at least one optical sensor arrangement (e.g., camera unit, typically operable in visible and/or infrared wavelength range) 120 configured for collecting one or more images of a scene, and an acoustic sensor array 130 formed by an array of two or more microphones 130a, 130b, 130c, configured for recording acoustic signals from the same scene. The system further includes a control unit 500 including at least one processor and memory circuitry (PMC). The control unit 500 is configured and operable for operating the at least one optical sensor arrangement 120 and acoustic sensor arrangement 130, to receive sensing data therefrom, and to process the sensing data and provide output data to one or more operator. Generally, system 100 may also include one or more location sensors 140. The location sensor 140 may be configured to provide data on geo-location thereof, such as a global positioning system (GPS) unit. Additionally, or alternatively, the location sensor may provide data on relative location using one or more accelerometers, gyroscope, or any other type of inertial measurement unit IMU. The optical sensor arrangement may preferably utilize a sensor array and optical elements providing image data of a scenes. However, in some embodiments, the optical sensor arrangement may utilize one or more optical sensors without optical elements. Such one or more optical sensors may provide data of variation in background illumination conditions and may provide optical signals indicative of flash of light that may be associated with a blast, flare, etc. the use of an arrangement of optical sensors can provide certain angular data of origin of variation in illumination conditions, which while being limited with respect to image data, may indicate sufficient data on a flare, blast or other events within certain range.

The system 100 is configured to collect and process data on its surroundings, and preferably directed to data on launch of projectiles or rockets and flight thereof. Accordingly, the control unit 500 is configured for receiving and processing input optical data (e.g., in the form of a plurality of image data pieces) and input acoustic data, and to process the input data to identify one or more signal portions indicative of respective events. For example, the control unit 500 may be configured for processing the input optical and input acoustic data for determining events associated with launch, flight, or impact of one or more projectiles or rocket. Such events may be in the form of illumination flash or fast-moving object collected in the optical image data, and/or blast or explosion sound, or sounds associated with operation of rocket engine collected in the acoustic input data. In this connection the term projectile is used herein in general to describe a flying object, which may or may not include a thrust source. The path of passive projectile is typically parabolic due to gravitation (where applicable) while rockets that include thrust source may be characterized by relatively linear path of flight. The present technique may generally utilize one or more pre-known data pieces indicative of characteristic flight path, and signal signatures of projectiles to differentiate between passive projectiles and active projectiles such as rockets.

Upon identifying at least one first signal, indicative of an event, using either one of the optical and acoustic input data, the control unit 500 may flag the respective input data and store respective information in a selected memory sector. The control unit may also determine respective additional data including relative source location of the first signal as determined from the processed input data, location of the system at time of detecting the first signal etc. Generally relative source location of the first signal may be determined as angular location relative of a selected axis, i.e., azimuth, of event generating the first signal.

The control unit 500 may also operate to classify the collected first signal as being indicative of one or more characteristic events. Such classification may for example differentiate between one or more blast or launch types, projectile flight or one or more other general classifications of events that may generate the first signal.

Additionally, the control unit 500 may proceed in collecting and processing input data, to identify additional events having certain correspondence with the first signal, and/or processing previously collected input data recorded and stored in a respective memory unit or buffer storage. For example, given a first signal indicative of an event in the form of flash of light collected by the optical sensor arrangement 120, the control unit 500 may operate to identify data on a respective event in a second signal, e.g., in the form of blast sound and/or acoustic signals associated with projectile flight, collected by the acoustic sensor arrangement 130. Alternatively, in response to a first signal in the form of blast sound collected by the acoustic sensor arrangement 130, the control unit 500 may operate to identify past second signal in the form of illumination flash in the optical input data, or future event in the form of dust cloud (in response to explosion) or in the form of fast-moving projectile (in response to launch sound) collected by the optical sensor arrangement 120.

Generally, for each event instance, the control unit 500 may operate to register relative location of the event (typically azimuth location), time of collection of the event, system location, and event classification data. The control unit may operate to determine correlations between events collected by the optical sensor arrangement 120 and respective events collected by the acoustic sensor arrangement 130 to determine data on time different between signal of the event collected by optical radiation and signal of event collected by acoustic waves. Using the time difference, and pre-stored data on speed of propagation of optical radiation and speed of propagation of acoustic waves, the control unit can determine distance between the system 100 and the event.

The control unit may further operate to determine event progress based in input signal data collected by the same sensor arrangement that collected the first signal, to enable tracking of progressing event. However, in various situations, only optical or only acoustic monitoring may be limited. The present disclosure thus utilizes combined optical and acoustic monitoring that enables determining distance data based on signal velocity differences and different characteristics of signal detection using optical or acoustic sensors.

Determining distance between the system and the event, combined with angular data on event location, allows the system according to the present disclosure to determine event location. Generally, angular data on event location may be determined based on location of the optical signal as collected by the optical sensor arrangement 120, using pre-stored data on imager orientation, and optionally data on system orientation. Additionally of alternatively, the acoustic sensor arrangement 130 includes an arrangement of two or more acoustic sensors, exemplified by sensors 130a to 130c. The plurality of acoustic sensors enables the control system 500 to extract angular orientation data by applying beamforming techniques to the acoustic data collected by respective channels, where each channel is collected by a respective sensor of the plurality of acoustic sensors.

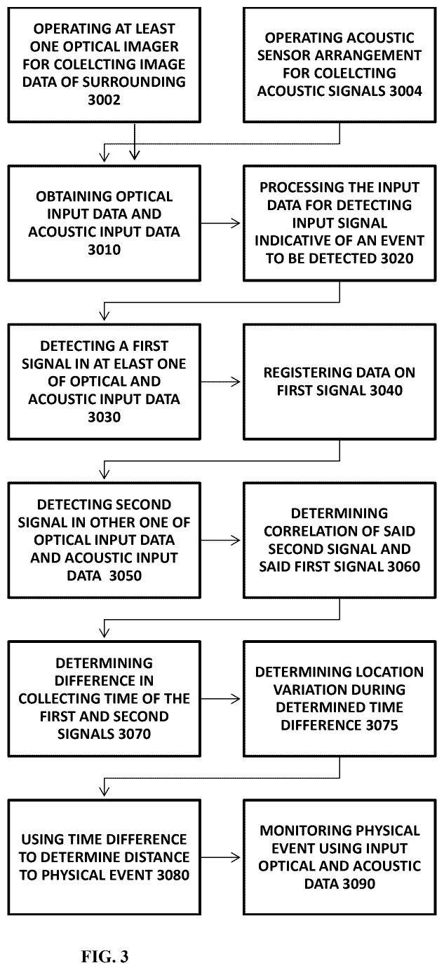

Reference is made to FIG. 2 schematically illustrating a control unit 500 according to some embodiments of the present disclosure. The control unit 500 generally includes at least one processor 510 and memory 520, herein also referred as processor and memory circuitry (PMC). The control unit 500 further includes an input/output I/O module 530 and may also include a user interface 540 including e.g., display, and user input arrangement. The at least one processor 510 and memory 520 may operate together as PMC operable to implement computer readable instructions for performing a method for detecting and/or monitoring one or more events based on input data collected by the at least one optical sensor arrangement 120 and acoustic sensor arrangement 130, and/or input data stored in the memory 520 thereof, as described herein. The PMC may operate using one or more software and/or hardware modules, generally comprised in the PMC and configured to perform selected operations as described herein.

Typically, the memory 520 may carry pre-stored instructions for operating the at least one processor 510 in accordance with the technique described herein. Additionally, the memory 520 may carry pre-stored data including characteristic optical and acoustic signatures of various events such as projectiles, and data on corresponding path patterns. The present technique may utilize such pre-stored data for classification of collected signals to determine expected path and may further analyze such estimations using additional signals collected by optical and/or acoustic sensors arrangements to determine one or more of projectile path, estimated impact location, and launch location.

In this connection, FIG. 3 is a block diagram exemplifying a method for determining event location and monitoring events according to some embodiments of the present disclosure. As shown, the method generally includes operating at least one optical sensor arrangement for collecting optical input data on surroundings thereof 3002 and operating an acoustic sensor arrangement for collecting acoustic input data 3004. Obtaining optical input and acoustic input data from the respective acquisition units 3010, provides input data for processing. The processing is generally directed at detecting input signal associated with one or more first signals indicative of an event 3020, collected in the optical or acoustic input data. To this end the method may utilize processing of various input signals in accordance with pre-stored data of event signatures to identify one or more input signals that have high correlation to one or more signatures of events to be identified. In some embodiments a first signal may be determined as an event signal in accordance with certain signal characteristics that may not directly correlate to a known signature, if amplitude, amplitude variation of total power of the signal exceed a selected threshold. Such signal may e.g., indicate a shockwave, explosion, blast, launch etc., even of not directly identified based on event signature. Upon detection of input signal indicative of a first signal in either one of the optical or acoustic input signals 3030, the method utilizes registering data on the first signal 3040. Such data may include one or more data piece such as angular location (azimuth and/or elevation) of signal source, signal characteristic signature, time of signal collection and sensor arrangement location at time of signal collection.

In this connection a first signal may be associated with input signal indicating data on an event to be detected and/or monitored. For example, an event to be monitored may be any type of blast, explosion, launch of one or more projectiles or rockets, impact of such projectile or rocket, as well as projectile or rocket in flight. Accordingly input signal indicative of a first signal may be image data indicative of a blast, explosion, etc., indicative of launch or impact, as well as image data indicative of one or more projectiles of rockets in flight. Additionally, input acoustic signal indicative of a first signal may be blast or explosion sound, whistle sound or other sound indicative of flight of a projectile or rocket. It should be noted that the first signal indication may be detected in either one of the optical and acoustic input data. More specifically, in some situations, optical signal of an event may be detected first, while in some other situations, acoustic signal of such event may be detected first. This is generally associated with characteristics of the scene, i.e., level of noise, event location (e.g., event located behind a barrier and cannot be directly observed) etc.

Detecting a first signal 3030 and registering data on the first signal 3040 may generally include processing the input data, being optical and/or acoustic data, detecting an event (generally one or more) associated with selected event parameters, and determining data on the event. Such data may include one or more event parameters such as event amplitude that may be measured by light intensity and/or acoustic signal amplitude, type of event (e.g., based on event characterization) etc. Additional event data includes event location. Generally, the event location is estimated, and may utilize relative angular location determined based on the input signal, and estimated distance. Registering data on the first signal at the memory unit enables the present technique to determine correspondence between the first signal and a second signal, determined by signal collection using the other one of optical and acoustic sensing techniques. In some embodiments of the present disclosure, registering data on the first signal may include registering data on location of the system at the time of collecting input signal associated with the first signal. Using system location data allows for determining a general estimated location of the first signal and using such general estimated location to determine correspondence between the first signal and a second signal, even if the system is moving during the time between collection of event signals.

The method further continues collecting and processing input signals to detect data on a second signal 3050, typically collected using the other one of optical and acoustic sensors (i.e., the optical sensor arrangement and/or acoustic sensor arrangement). To this end, the method may include processing various input signals and determine signal portions having probability to be indicating a second signal and determining correlations between the second signal and the registered data on the first signal 3060. Such correlation may be based on event data and characteristics, estimated event location (e.g., azimuth), time and other parameters. Generally, the correlation may be determined based on angular location, type of event and any other processing technique that may be used.

When signal data is determined to indicate a second signal and to correspond to a first signal, the method includes determining a time difference between data collection of the first signal and time of data collection for the second signal 3070. Generally, as indicative above, the first and second signals are labels indicating signal portions collected in either acoustic or optical sensing techniques. Accordingly, time difference is signal collection may indicate distance of the event, as the optical and acoustic signals propagate with different velocities.

For example, given the first signal collected at time t₁ using the optical sensor arrangement, and given a corresponding second signal collected at time t₂ using the acoustic sensor arrangement. As the actual event occurred at distance D from a given position where a system operating the present technique is located, the distance D can be determined by:

$$D = \frac{cv ( {t}_{2} - {t}_{1} )}{c - v}$$

where c is the speed of light and v is the sound velocity. Thus, time difference between first and second signals collected by optical and acoustic sensing respectively can be determined 3080.

In some embodiments as indicated above, the system operating the presently described method may be moving between time of collection of first signal, and time of collection of second signal data. Accordingly, the method may operate to determine change in location of the system itself 3075 between the collection times t₁ and t₂. To this end the present technique may utilize location data provided by location sensor (140) to determine variation in system location between the collection times t₁ and t₂. Using the variation in location, the present technique may operate to determine distance to the event 3080 by determining the time required for the first signal and the second signal, including shift in location of the system.

Following determining data on physical location of the event, and recording thereof using optical and acoustic sensing technique, the method according to some embodiments of the present disclosure may operate the optical sensor arrangement and acoustic sensor arrangement for monitoring propagation of the event 3090, take required actions if needed, and send reporting data in accordance with system operational instructions. For example, given an event associated with launch of a rocket, monitoring the event may include collecting image data and acoustic data indicative of path of flight of the rocket, and optionally estimating a rocket trajectory up to a potential point of impact.

The types of collected signals mentioned above include short signals (e.g., shockwave, blast, explosion, etc.), and continuous signals such as flight sound or image of flying object/projectile. An exemplary characteristic of continuous signals may include rate of angular variation. The rate of angular variation indicates a relation between projectile velocity, its distance from the sensor arrangement, and characteristic path. Additionally, continuous signal may include signal signature that may be associated with type of projectile. Such signal signatures are typically collected and use to determine correlation between first and second signals.

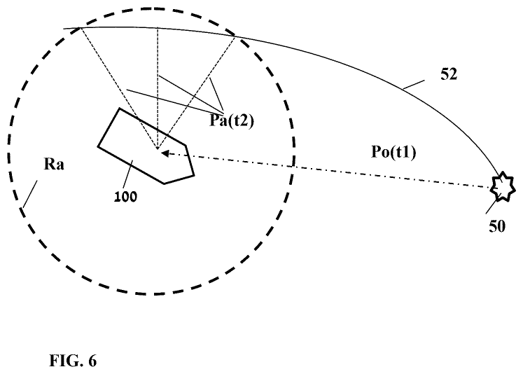

For example, a first signal may be associated with registration of light burst collected by certain pixels of the optical sensor arrangement 120. By processing the image data, such first signal may be characterizing by a blast or launch. Using imager calibration, angular location of the event can be determined based on the specific pixels in which the light burst is detected, and estimated distance may be determined by processing effective size of nearby elements using image calibration data. Such data on the first signal may be collected and stored to enable comparison to a second signal. Typically, a short time after collection of first signal, a second signal in the form of blast sound may be collected by the acoustic sensor arrangement 130. In this connection, estimated event location may be determined by processing the input acoustic signal collected by the different acoustic sensors of the acoustic sensor arrangement 130. Such processing may utilize phase steering techniques, by determining phase/time variations in collected signals between the sensors of acoustic sensor arrangement 130. Given the collected signals correspond with respect to angular location, the two signals may be considered as first and second signals, relating to a common physical event, thereby enabling to determine event location. Further, as exemplified in FIG. 6 below, a first signal in the form of a light burst of launch may be followed by a second signal in the form of acoustic buzz associated with flight sound of a projectile. The acoustic signal may be correlated to the first signal indicating launch of a projectile in according with signal characteristics such as angular velocity of flight buzz.

Further, continuous acoustic signals also provide Doppler shift data indicative of closing velocity of the event with respect to the sensor arrangement. Further, monitoring Doppler shift using acoustic sensing enables to determine additional data on projectile velocity, its path and distance from the sensor arrangement.

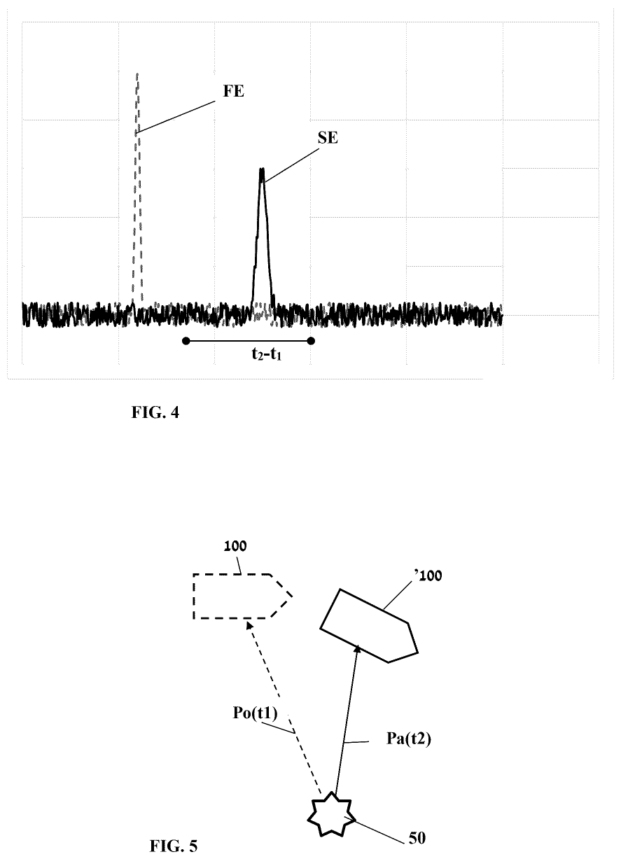

Time difference between collection of an optical signal and respective acoustic signal is illustrated in FIG. 4. This figure shows a first burst signal FE collected by optical imaging at time t₁, and respective second signal SE collected by acoustic sensors at time t₂. Due to differences in properties of the signals, the two signals may vary in certain features. The present technique may utilize one or more signal parameter such as estimated angular location, correlation is signal structure, etc. to determined correspondence between the signals indicating the first and second signals, and thus determine if the first and second signals relate to a common physical event. Generally, as indicated above, the present technique may determine an estimation of location of the events and update the estimation of location in accordance with data on movement of the system itself between times t₁ and t₂. Accordingly, angular location data for the first signal, may be updated in accordance with location change of the system when determining correlation with a second signal. Further, in determining distance to the actual event based on time difference between the first and second signals, change in location of the system may be considered. Given distance and angular location, the present technique can determine event position based on optical and acoustic signals indicative if the event.

Further, FIG. 5 exemplifies a situation where a vehicle 100, carrying a system as exemplified in FIG. 1 according to some embodiments of the present disclosure, moves from first location (marked by 100) to a second location 100′ between collection of optical signals indicating first signal and collection of acoustic signal indicating the corresponding second signal. As shown, certain event 50 transmits optical an acoustic signals that propagate with respective velocities. System 100 at certain location collected optical signal Po(t1) at time t₁. The vehicle moves and collects acoustic signal Pa(t2) indicative of event 50 at a different location, marked by 100′. At time t₂. To determine event location in such situation, the present technique may utilize location sensor (140 in FIG. 1) providing data on location variation of the system, combined with data on angular location θ1 and θ2 of the first and second signals Po(t1) and Pa(t2) respectively. Using data on the collection times t₁ and t₂, respective angular locations θ1 and θ2 and location data indicative of change of location of the system 100 to 100′, enables the technique to determine location of the event 50.

FIG. 6 exemplifies a further exemplary situation where a system 100 according to some embodiments of the present disclosure collects a first (e.g., optical) signal Po at time t1 associated with launch of projectile 50. At time t2 after t1, the acoustic sensor arrangement collected flight sounds Pa(t2) indicative of projectile flight within range Ra for detecting the signal. Based on angular velocity of the flight sound, and time difference between signal times t1 and t2, the present technique may operate to determine projectile path 52, velocity, distance, and launch location. Continuously collecting acoustic signals may also be used to determine Doppler shift in flight sounds and accordingly to determine crossing point where closing velocity of the projectile changes sign, indicating a specific selected point along path of the projectile.

Generally, the present technique may utilize one or more artificial intelligence techniques for determining correlations between the first and second signals. Further, the present technique may utilize determining data on location of an event, for determining path of moving elements such as projectiles or rockets, and for using the determined path to determine possible impact locations. For example, using collected signals indicative of first and second signals such as optical image of projectile in air, and sound of the projectile collected a short time after optical detection of the projectile, the present technique can determine projectile distance. Operating for determining projectile distance again, following a short (e.g., millisecond or more) time delay, the present technique may operate to identify the projectile in a slightly different location, and to determine its path.

Using data on path of a flying object (projectile, rocket, etc.) the present technique may utilize one or more path prediction techniques, including e.g., at least one of physical pre-stored model and path history of the flying object to determine/extrapolate future path of the object. This enables determining possible locations of impact, and/or additional data on one or more identified flying objects said one or more events.

More specifically, utilizing time difference in collection of optical and acoustic signals, combined with angular location data obtained directly from optical sensor arrangement and/or array of acoustic sensors by beamforming techniques, the present technique can determine three-dimensional location of an identified object/event. Identifying object speed and heading may be done by a one or more instances of detection of object location and using object speed and heading short range path can be determined. In this case, the present technique may further utilize one or more of physical modeling of flight path, object characterization (e.g., projectile or rocket having internal propulsion) to estimate future path and possible impact location. In response to estimation of an impact location, the present technique may operate to generate an alert signal in accordance with object characteristics and estimated impact location.

As indicated, the technique of the present invention may utilize input using two or more, and preferably three or more sensing elements including at least one optical sensor arrangement and at least one acoustic sensor arrangement. In some preferred embodiments, the present technique may utilize input data on system location using one or more location sensors, for determining event location while being mobile, i.e., in situations where the optical and acoustic signals are collected at different system positions due to system's moving pattern.

To this end, the present technique may operate to determine an estimated location of an event, using one or more data pieces collected by either one of the optical or acoustic sensors. Upon detection of a second signal indicative of the event, associated with the detected first signal indicative of the event, the technique may determine data on change of location of the system itself (and/or the sensors thereof).

1. A method for detecting location and/or path of event comprising:
(a) obtaining input data comprising optical input data from at least one optical sensor arrangement (camera) and acoustic input data from an acoustic sensor arrangement comprising two or more acoustic sensors;
(b) processing said input data, said processing comprising detecting a first signal indicative of one or more selected events in at least one of the optical input data and acoustic input data;
(c) in response to detecting an event in said at least one of the optical input data and acoustic input data, registering a time of collection of said first signal and determining an estimated location of said event,
(d) processing input data of other one of said optical input data and acoustic input data for determining input signal indicative of a second signal associated with said event,
(e) determining time of collected data indicative of said second signal detected in said at least one of the optical input data and acoustic input data and determining a time difference between time of collected data indicative of said event; and
(f) utilizing said time difference and determining location of said event.

2. The method of claim 1, further comprising obtaining location data from one or more locations sensors, determining change in location during time between time of collected data indicative of said event in said optical input data and said acoustic input data, and determining location of said event in accordance with said time difference and said change in location.

3. The method of claim 1, further comprising obtaining location data from one or more orientation sensors, determining change in orientation during time between time of collected data indicative of said event in said optical input data and said acoustic input data, and determining location of said event in accordance with said time difference and said change in orientation.

4. (canceled)

5. The method of claim 1, wherein said at least one first signal is indicative of one or more of the following: launch flash, launch blast, detonation flash, detonation blast, detonation impact, flight flare, flight sound, projectile's movement.

6. The method of claim 1, wherein said second signal and said at least one first signal being indicative of a common event.

7. The method of claim 1, wherein said second signal is indicative of a continuation event associated with event detected in said first signal.

8. The method of claim 7, wherein said at least one first signal being associated with launch of a projectile and said second signal being indicative of flight of said projectile.

9. The method of claim 1, further comprising processing said input data for classifying said at least first signal and obtaining pre-stored data indicative of one or more items associated with said at least one first signal and determining data on object type of said at least one first signal.

10. The method of claim 9, further comprising using one or more pre-stored parameters of an item associated with said at least one first signal for determining at least one of anticipated path and anticipated impact position of said item.

11. The method of claim 1, further comprising determining location of one or more events in accordance with time difference of data indicative of said one or more events in said optical input data and acoustic input data at a selected processing rate, thereby determining path of movement of said one or more events.

12. The method of claim 1, wherein said second signal being a continuous signal, said method comprising determining data on angular velocity of source of said second signal and determining correspondence between said second signal and said first signal in accordance with event characteristics and said angular velocity.

13. The method of claim 12, further comprising determining Doppler shift variation of said second continuous signal and determining closing velocity of said event.

14. (canceled)

15. The method of claim 12, further comprising processing data of said first signal for determining one or more event characteristics and determining correlation between said second signal and said first signal in accordance with at least one of typical projectile velocity and path curve variation.

16. The method of claim 11, further comprising processing data on said path of movement of said one or more events and using at least one of physical pre-stored model and path history of said one or more events and determining expected future path of said one or more events.

17. The method of claim 16, further comprising determining expected impact point based on determined path of a projectile associated with said event.

18. The method of claim 1, wherein said detecting input signal indicative of at least one first signal in at least one of the optical input data and acoustic input data comprises processing said input data using machine learning classification for detecting said at least one first signal.

19. The method of claim 1, wherein said determining an estimated location of said at least one first signal comprises processing optical input data and determining at least angular location of said at least one first signals in said optical input data.

20. The method of claim 1, wherein said determining an estimated location of said at least one first signal comprises processing acoustic input data collected by said two or more acoustic sensors and determining relative angular position of source of acoustic signal indicative of said at least one first signals using phase relations of acoustic signals collected by said two or more acoustic sensors.

21. The method of claim 1, wherein said determining input signal indicative of a second signal associated with said at least one first signal comprises determining correlation between estimated location of said at least one first signal and estimate location of said second signal and determining that said second signal is associated with said at least one first signal in response to correlation exceeding an event correlation threshold.

22. A system comprising at least one optical sensor arrangement, an acoustic sensor arrangement comprising two or more acoustic sensors, and a control unit adapted for receiving optical input data from said at least one camera unit and acoustic input data from said acoustic sensor arrangement;
the control unit comprises at least one processor and memory unit and is configured for:
(a) obtaining input data comprising optical input data from at least one optical sensor arrangement (camera) and acoustic input data from an acoustic sensor arrangement comprising two or more acoustic sensors;
(b) processing said input data, said processing comprising detecting input signal indicative of at least one first signal in at least one of the optical input data and acoustic input data;
(c) in response to detecting an event in said at least one of the optical input data and acoustic input data, registering a time of collection of said event and determining an estimated location of said at least one first signal,
(d) processing input data of other one of said optical input data and acoustic input data to determine input signal indicative of a second signal associated with said at least one first signal,
(e) determining time of collected data indicative of said second signal detected in said at least one of the optical input data and acoustic input data and determining a time difference between time of collected data indicative of said at least one first signal and said second signal; and
(f) utilizing said time difference and determining location of said at least one first signal; and
generating output data indicative of at least location of said at least one first signal.

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. A program storage device readable by machine, tangibly embodying a program of instructions executable by the machine to perform a method for detecting location and/or path of event comprising:
(a) obtaining input data comprising optical input data from at least one optical sensor arrangement (camera) and acoustic input data from an acoustic sensor arrangement comprising two or more acoustic sensors;
(b) processing said input data, said processing comprising detecting input signal indicative of at least one first signal in at least one of the optical input data and acoustic input data;
(c) in response to detecting an event in said at least one of the optical input data and acoustic input data, registering a time of collection of said event and determining an estimated location of said at least one first signal,
(d) processing input data of other one of said optical input data and acoustic input data for determining input signal indicative of a second signal associated with said at least one first signal,
(e) determining time of collected data indicative of said second signal detected in said at least one of the optical input data and acoustic input data and determining a time difference between time of collected data indicative of said event; and
(f) utilizing said time difference and determining location of said at least one first signal; and
(g) generating output data indicating of at least said location of said at least one first signal.

42. (canceled)
